(19) United States
(12) Patent Application Publication
(10) Pub. No.: US 2026/0318538 A1
(43) Pub. Date: Oct. 15, 2026

(54) FIREPLACE

(71) Applicant: Mika Tapio REIJONEN, Helsinki (FI)

(72) Inventor: Mika Tapio REIJONEN, Helsinki (FI)

(21) Appl. No.: 19/486,318

(22) PCT Filed: May 23, 2024
(86) PCT No.: PCT/FI2024/050262

§ 371 Date: Nov. 20, 2025

(30) Foreign Application Priority Data
May 24, 2023 (FI) 20237098

(51) Int. Cl. F24B 1/24; A61H 33/06; F24B 1/189; F24B 1/197

(52) U.S. Cl. CPC F24B 1/24; A61H 33/063; F24B 1/189; F24B 1/197; A61H 2033/061; A61H 2033/068; A61H 2201/0257

(57) ABSTRACT

The object of the invention is a fireplace, which includes a firebox and a flue, and at least on the metal roof of the firebox there is contact with bricks that conduct heat very well, the thermal conductivity is more than 50 W(mK)−1 (4)), with, and after that there are heat conducting and storing bricks or/and heat conducting and storing stones.

### FIELD OF THE INVENTION

The object of the invention is a fireplace. The purpose of the invention is to reduce heat loss due to high flue gas temperatures in the chimney.

### BACKGROUND OF THE INVENTION

The problem with fireplaces is often big waste heat in the chimney. The combustion takes place at a high temperature, which results in the most energy and the least emissions, and these things are currently well managed in the firebox. The big problem is that in fireplaces, such as stoves. ovens and sauna stoves, heat is not store after the hearth. There are already different solutions for this, which are suitable for large storage furnaces, where the flue gases also circulate downwards and then upwards again. There are problems with this, for example, to getting a flue to pull.

Many people have tried to get a heat storing in their stoves. A common method is to place insulating brick rings placed the metal chimney. Nevertheless, the waste temperatures of the flue gases are high. One way is to put, for example, soapstone tiles inside a chimney in flue gases. This solution can soot the stones, and on the other hand, it must be ensured that the chimney does not get blocked or otherwise.

Heat storing stoves and continuous heating stoves are basically the same, i.e. there is a heat storing material outside the metal firebox.

Solid, liquid and gaseous substances can be burned in the fireplace. It is usually burn wood, pellets or briquettes, but also liquids and gases.

Firebox solutions are well known, such as air intake openings, which are usually primary and secondary from the front of the fireplace to the upper space of the firebox and sometimes also from the back, i.e. tertiary air intake. Outer shell solutions for fireplaces are also well known, such as brick, tile and stone shells.

### OBJECT OF THE INVENTION

The purpose of the invention is a fireplace where the waste of energy in the chimney is as little as possible and the use of the fireplace is easy, for example an ignition.

### DESCRIPTION OF THE INVENTION

The invention is characterized by what is presented in the characterizing part of the attached claim 1. Many have tried to reduce the waste heat of the flue gases lower than it is now.

A lot of efforts have been made to lower the temperature of wasted flue gases, but stoves and sauna stoves have still very high flue gas temperatures. Now the flue gas temperatures have been halved in the tests, for example, which is a very big thing from both the environmental and economic aspects.

One invention is to take retaining stones into the flue, where they unfortunately become sooty and can block the flue channel.

The brick and stone industry is well known. Silicon carbide bricks are refractory materials with a silicon carbide content of 72-99%. Aluminium nitride bricks contain aluminium nitride and, for example, these conduct heat very well, over 50 W(mK)−1.

Bricks and stones that conduct and store heat well are, for example, magnesite, which is based on magnesium oxide (MgO) and calcium oxide (CaO), and the MgO content is over 80%. Magnetite brick contains magnetite (Fe304). There are also magnesia bricks, alumina bricks, MgO—C bricks and natural stones such as olivine stone, olivine diabase stone and soapstone or mixtures such as olivine concrete made from crushed olivine with cement.

Stoves and sauna stoves are easy to use compared to large heat storage stoves, which have problems to getting a flue to pull, for example.

It is not necessary to have heat storing elements on the outer walls of the firebox, and thus the visibility of the fire is excellent and different design solutions are possible.

In the patent publication EP2330352 Fireplace, Nunnanlahden Uuni Oy shows a fireplace where the flue gases pass to the heat storing mass, between the soapstone plates.

In the patent publication EP2213945 Combustion apparatus and method of increasing heat extraction from a combustion apparatus, Ecco Stove Ltd, there is a material that stores heat in the flue gas, such as a material based on silicon carbide.

In the patent publication FR2252781, Irradiation elements incorporated in an oven consists of silicon carbide radiants incorporated in fire grate embrasure, Coudamy Jacques, there is silicon carbide in the flue gas.

In the patent publication CZ28883U1 Heat accumulation apparatus, especially for ovens or fireplaces, ROMOTOP spol. s r.o., and in the patent publication CZ27361U1 Device for additional use of combustion products heat and heat accumulation, particularly for ovens or fireplaces, ROMOTOP spol. s r.o., an oven or fireplace is presented, which has a heat-storing material around the flue and not across the roof of the firebox.

In the patent publication EP1342962 Storage heater, F. Huemer GmbH, an oven is presented in which an element made of a material with a thermal conductivity of 4-9 W(mK)−1 is placed on at least one outer wall of the firebox, which is therefore not placed on the roof of the firebox.

### BRIEF DESCRIPTION OF THE FIGURES

FIG. 1 is a principal view of a fireplace, which includes a firebox (1) and a flue (2), is a stove. At least the top of the metal roof (3) of the firebox (1) is in contact with very well heat-conducting bricks with a thermal conductivity of more than 50 W(mK)−1 (4), and after that there are heat-conducting and storing bricks (5) or/and stones that conduct and store heat (6). The fireplace has a metal container (7) with an adjustable valve (8). The fireplace has a 10 mm steel roof of the firebox in contact with silicon carbide bricks that conduct heat very well and there are gaps between them, and then there are magnesite bricks that conduct and reserve heat with gaps. The bricks are in a metal container with an adjustable valve to release air from the metal container. In addition, there is a metal appendix (10) in the firebox to obtain a turbulent flow.

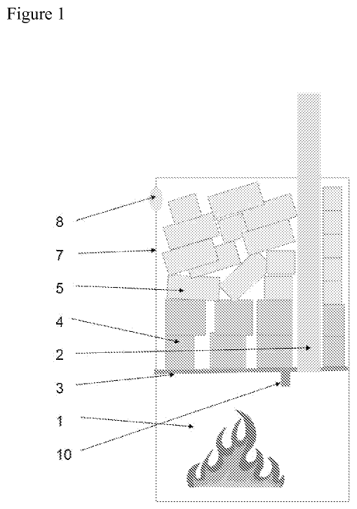

FIG. 2 is a principal view of a fireplace, which includes a firebox (1) and a flue (2), is a sauna stove. At least the metal roof (3) of the firebox (1) is in contact with very well heat-conducting bricks with a thermal conductivity of more than 50 W(mK)−1 (4), and after that there are heat-conducting and storing bricks (5) or/and stones that conduct and store heat (6). The fireplace has a metal container (7) with an opening lid (9). In addition, there is a metal appendix (10) in the firebox to obtain a turbulent flow.

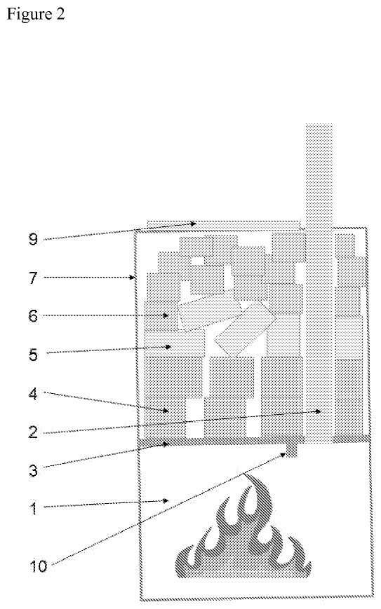

### DETAILED DESCRIPTION OF PREFERRED EMBODIMENTS

A fireplace, which includes a firebox (1) and a flue (2), characterized by the fact that at least the metal roof (3) of the firebox (1) there are very well heat-conducting bricks with a thermal conductivity of more than 50 W(mK)−1 (4), with, including for example silicon carbide, silicon nitride, beryllium oxide or aluminium nitride. and after that there are heat-conducting and storing bricks (5) or/and heat-conducting and storing stones (6), for example containing, for example, magnesite, magnetite, magnesia, alumina or MgO—C or/and stones (6) containing olivine, olivine diabase, granite or soapstone or olivine concrete made from olivine crushed with cement. There are gaps between the bricks and stones (4, 5, 6). that the bricks or stones (4, 5, 6) are in contact with the flues. The firebox roof (3) is made of steel, cast iron or copper, and its thickness is 4-20 mm.

### EXAMPLES

### Example 1

The fireplace has a metal roof of the firebox, which is 10 mm steel, on top of it in contact with silicon carbide bricks that conduct heat very well and there are gaps between them, and then there are magnesite bricks that conduct and store heat with gaps. The bricks are in a steel metal container with an adjustable valve to release air from the metal container. In addition, there is a steel appendix in the firebox to obtain a turbulent flow.

### Example 2

The stove has a metal roof of the firebox, which is 10 mm steel, on top of it in contact with silicon carbide bricks, which conduct heat very well, and between them there are gaps, and after that there are magnesite bricks, which conduct and store heat, with gaps, and olivine diabase stones, which conduct and store heat, with gaps. The bricks and stones are in a steel metal container with an opening door. In addition, there is a steel appendix in the firebox to obtain a turbulent flow.

### Example 3

The stove has a metal roof of the firebox, which is 10 mm steel, in contact with silicon carbide bricks that conduct heat very well and have gaps between them, and then there are olivine diabase stones that conduct and store heat in the gaps. The bricks and stones are in a steel metal container with an opening door. In addition, there is a steel appendix in the firebox to obtain a turbulent flow.

It is obvious to those skilled in the art that the invention is not limited to the details of the above embodiment. It will be apparent to one skilled in the art, for example, that the surface, shape and size of the fire pit roof can be different.

According changing rules and a new PCT rule 1 Jul. 2010 46.5, 66.8, 72.2 (c-bis) there is presented paragraphs where the changes are in this priority application FI20237098.

In the intermediate decision of this priority application FI20237098 by the Finnish Patent and Registration Office, it was presented the next two reference Y category publications.

In the FR 2847336 A1 Gourhel Alain (21 May 2004) it is presented the solution, which includes the circulating heat transfer fluid (Claim 1).

In the CZ 288883 U1 ROMOTOP Spol. s r.o. (30 Nov. 2015) it is presented the solution where the metal plate(s) is/are between the heat storage brick plates.

1. A fireplace, which includes a firebox and a flue, characterized in that at least on top of the metal roof of the firebox very well heat conducting bricks with a thermal conductivity of more than 50 W(mK)−1 are in contact, with, and after that there are heat conducting and storing bricks or/and heat conducting, and storing stones.

2. A fireplace according to claim 1, wherein the very well heat conducting bricks contain, for example, silicon carbide, silicon nitride, beryllium oxide or aluminum nitride.

3. A fireplace according to claim 1, wherein the heat conducting and storing bricks contain, for example, magnesite, magnetite, magnesia, alumina or MgO—C or/and the stones contain olivine, olivine diabase, granite or soapstone or olivine concrete made from crushed olivine with cement.

4. A fireplace according to claim 1, wherein the bricks or stones are of any shape and size, and include, for example, holes.

5. A fireplace according to claim 1, wherein there are gaps between the bricks and/or stones.

6. A fireplace according to claim 1, wherein the bricks and/or stones are in contact with the flues.

7. A fireplace according to claim 1, wherein the hearth roof is made of steel, cast iron or copper, and its thickness is 4-20 mm.

8. A fireplace according to claim 1, wherein the fireplace is a stove with a metal container with an adjustable valve.

9. A fireplace according to claim 1, wherein the fireplace is a stove in which the metal container is on an openable lid.

10. A fireplace according to claim 1, wherein the metal appendix is in the firebox and/or in the flue to obtain a turbulent flow.
